(19) United States
(12) Patent Application Publication
(10) Pub. No.: US 2025/0161886 A1
(43) Pub. Date: May 22, 2025

(54) ZINC IMIDAZOLE SALICYLALDOXIME-BASED ADSORPTIVE MEMBRANES FOR REMOVAL OF METAL IONS FROM AQUEOUS SOLUTIONS

(71) Applicant: THE BOARD OF REGENTS OF THE UNIVERSITY OF OKLAHOMA, Norman, OK (US)

(72) Inventors: Ngoc Thi-Nhu BUI, Norman, OK (US); Thi Cam Van LE, Morgantown, WV (US)

(73) Assignee: THE BOARD OF REGENTS OF THE UNIVERSITY OF OKLAHOMA, Norman, OK (US)

(21) Appl. No.: 18/873,924

(22) PCT Filed: Jul. 25, 2024
(86) PCT No.: PCT/US2024/039514

§ 371 Date: Dec. 11, 2024

Related U.S. Application Data
(60) Provisional application No. 63/517,297, filed on Aug. 2, 2023.

(51) Int. Cl. B01D 69/14; B01D 67/00; B01D 69/02; B01D 71/34; B01D 71/60; C02F 1/44; C02F 101/20; C07F 3/06

(52) U.S. Cl. CPC B01D 69/147; B01D 67/0088; B01D 69/02; B01D 71/34; B01D 71/601; C02F 1/44; C07F 3/06; B01D 2323/081; B01D 2325/02832; B01D 2325/02833; B01D 2325/02834; C02F 2101/206

(57) ABSTRACT

Disclosed herein are transition and/or heavy metal cation-capturing membranes constructed from zinc imidazole salicylaldoxime (ZIOS) nanosheets deposited on membrane supports, and methods of making and using such metal cation-capturing membranes. In a non-limiting embodiment, the membrane support comprises polyvinylidene fluoride (PVDF) membranes which have been modified with polydopamine (PDA) and polyethyleneimine (PEI). Three exemplary methods for fabricating the metal cation-capturing membranes include (1) in-solution hydrothermal growth, (2) vacuum-assisted coordination growth, and (3) interfacial coordination growth methods. The membranes may be tuned regarding textural properties and the adhesion of the ZIOS to the membrane support.

### CROSS REFERENCE TO RELATED APPLICATIONS

This application claims benefit of U.S. Provisional Application Ser. No. 63/517,297 filed Aug. 2, 2023, which is hereby expressly incorporated herein by reference in its entirety.

### STATEMENT OF GOVERNMENT SUPPORT

Not applicable.

### BACKGROUND

At the energy-water-environment nexus, the geopolitical constraints on global metal supplies necessitate precise and energy-efficient separation technologies for sustainable recovery of metals from industrial wastewater while concomitantly decontaminating water at reduced waste management cost. Nickel and copper, for example, are widely used across industries, e.g., in catalytic industries, stainless steel production, energy production, aerospace industries, electronics, plating, and alloys, and hence are two of the most common heavy metals in electroplating wastewater. Meanwhile, Nickel ion- and Copper ion-containing wastewater may pose serious threats to human health including lung, kidney, gastrointestinal distress, pulmonary fibrosis, and skin. Energetically and environmentally efficient recovery of valuable metal ions from industrial wastewater (e.g., Ni²⁺, Cu²⁺, Co²⁺ or Mn²⁺) can provide a potentially tremendous revenue stream while alleviating environmental management costs, toward a circular economy and sustainable future of energy, water, and natural resources.

The predominant form of Ni and Cu found in industrial wastewater is positively charged Ni(II) and Cu(II) ions. Currently, a variety of techniques have been employed to recover these ions from wastewater. These methods include ion-exchange, electrochemical methods, extraction and adsorption. According to the World Health Organization (WHO) guidelines, the allowable concentration of Ni ion in drinking water must not surpass 0.07 mg/L. Adsorption is currently considered one of the most effective methods for remediating heavy metals in low concentrations due to its high efficiency, economic value, operational flexibility, and potential for reusability. Still, commonly used adsorbents and ion exchange resins have faced several setbacks involving low sorption capacity, slow sorption kinetics, and lack of specificity.

Meanwhile, membrane-based separation technologies have gained wide popularity for their high energy efficiency, cost-effectiveness, and low chemical consumption in the separation of metal ions. However, current established polymeric membranes have been designed for broad-spectrum ion removal, and therefore have limited selectivity, particularly when separating mixtures of metal ions with negligible differences in ionic sizes and charges. It is therefore important to design advanced materials capable of effectively and selectively separating and/or capturing target ions of interest from aqueous environments. It is to providing such advanced materials that the present disclosure is directed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The following drawings form part of the present specification and are included to further demonstrate certain aspects of the present disclosure, which may be better understood by reference to one or more of these drawings in combination with the detailed description of specific embodiments presented herein.

FIG. 1 is a schematic illustration which demonstrates the fabrication of ZIOS/PVDF-PDA-PEI membranes through three different approaches: (A—Method A) in-solution hydrothermal growth method, (B— Method B) vacuum-assisted growth method, and (C-Method C) interfacial growth method.

FIG. 2 shows morphological and compositional properties of ZIOS/PVDF-PDA-PEI membranes using Scanning electron microscope (SEM) images and inserted digital camera photographs of (a) PVDF, (b) PVDF-PDA-PEI and (c) ZIOS/PVDF-PDA-PEI (produced using Method A of FIG. 1); (d, e) Enlarged SEM images showing the length, width, and thickness of ZIOS nanosheets; (f) Cross-section and (g) Energy dispersive X-ray analysis (EDX) mapping of ZIOS/PVDF-PDA-PEI (Method A).

FIG. 3 shows results of Powder X-ray diffraction (PXRD) of a simulated ZIOS and ZIOS/PVDF-PDA-PEI membrane (a); and Fourier transform infrared (FTIR) of PVDF-PDA-PEI and ZIOS/PVDF-PDA-PEI membranes (b).

FIG. 4 shows the effects of PVA concentration on the dimensional textures and morphology of ZIOS in ZIOS/PVDF-PDA-PEI (Method A). SEM images (taken at two magnifications) and size-distributions of ZIOS/PVDF-PDA-PEI nanosheets (Method A) made without PVA (a-d). Nanosheets made with PVA (Mw 146,000-186,000) at g/mol concentration of 0.5% (e-h). Nanosheets made with PVA (Mw 146,000-186,000) at g/mol concentration of 1.0% (i-l). For the calculation of size distributions, width and length sizes are specified using dimensions shown in FIG. 2 (d-e).

FIG. 5 shows ZIOS nanosheets grown on PVDF-PDA-PEI using Method B (FIG. 1). SEM images of ZIOS/PVDF-PDA-PE membrane: top view (a,b), cross-sectional view (c,d) and EDX mapping (e).

FIG. 6 shows ZIOS nanosheets grown on PVDF-PDA-PEI using Method C (FIG. 1). SEM image of (a) the top ZIOS layer (a), a single ZIOS sheet (b), a cross-sectional view (c) and EDX mapping (d).

FIG. 7 shows a digital camera photo of a custom-made cell with 12-mL half-cell volumes used in breakthrough and metal ion capture/separation experiments. The membrane active area is 1.5 cm².

FIG. 8 shows Ni²⁺ ion capture performance using ZIOS/PVDF-PDA-PEI membrane synthesized by Method A with and without PVA 1%. (a) Ni²⁺ concentrations in feed and receiving stocks; (b) adsorption efficiencies of PVDF-PDA-PEI and ZIOS/PVDF-PDA-PEI membranes synthesized without and with PVA 1 wt. % after 180 min.

FIG. 9 shows Ni²⁺ ion removal performance of ZIOS/PVDF-PDA-PEI synthesized using Methods A-C of FIG. 1. (a) Ni²⁺ concentrations in feed and receiving stocks, and (b) Ni²⁺ adsorption efficiencies after 180 min.

FIG. 10 shows the effects of pH on Ni²⁺ ion removal performance (a) and the relationship between Zn²⁺ release and amount of adsorbed Ni²⁺ using ZIOS/PVDF-PDA-PEI membrane (Method A).

FIG. 11 shows FT-IR of ZIOS/PVDF-PDA-PEI membrane before and after Ni²⁺ ion capture.

FIG. 12 shows adsorption behaviors of the ZIOS/PVDF-PDA-PEI membrane in multi-component mixtures at (a) pH 2.5, (b) pH 5.0, and (c) pH 8.0, and correlation between the total concentrations of removed cations (i.e., Cu²⁺, Cu²⁺, Ni²⁺, Co²⁺ and Mn²⁺) versus released Zn²⁺ concentrations (d) and time (e); A proposed adsorption mechanism for metal cation adsorptions at different pH, showing two possible pathways, i.e., ion exchange mechanism (IEM) and ligand coordination mechanism (LCM) is shown in (f).

FIG. 13 shows the differentiation of adsorption mechanisms between Cu²⁺ and Ni²⁺ using in-situ Raman analysis of ZIOS/PVDF-PDA-PEI membrane when exposed to aqueous solution of single ions Cu²⁺ ions at 400 ppm (a) and Ni²⁺ ions at 400 ppm, pH 5.0 (b), and in-situ Raman analysis of ZIOS/PVDF-PDA-PEI membrane when exposed to equimolar aqueous solution of Co²⁺, Mn²⁺, Ni²⁺ and Cu²⁺ (100 ppm) at pH 2.5 (top), 5.0 (middle) and 8.0 (bottom) (c).

### DETAILED DESCRIPTION

Controllable translation of ion-selective capturing materials into membrane platforms for practical usage is not a small feat. Some efforts have been devoted to the integration of adsorbents into membranes. For example, vacuum filtration was used to fabricate two-dimensional (2D) graphene oxide (GO) for ion separation. Nevertheless, detachment of the adsorbent layer from the membrane substrates due to their weak physical interactions is commonly observed in this method. To address this issue, in-situ growth technique have been recently developed including in-situ growth of diverse adsorbents (e.g., GO, metal-organic framework, and zeolite) on membrane supports. While effective, this method faces several challenges involving the controllability of crystal orientation, surface uniformity and morphology, and intergrowth of the adsorbent materials. It is highly desired to establish a reliable and scalable approach which favorably enables the integration of these adsorbents onto membrane platforms with desired morphology and orientation. Furthermore, a reliable membrane synthesis method is required for any new families of adsorbents to tune their corresponding metal ion adsorption and separation efficiencies. It is to addressing this need that the present disclosure is directed.

Zinc imidazole salicylaldoxime supramolecule (ZIOS) is a material which can be used to selectively separate copper from a complex mixture of several coexisting ions with high sorption capacity, fast sorption kinetics, and promising ion selectivity. ZIOS also exhibited potential adsorption towards other divalent metal ions such as nickel. However, ZIOS remains in a powdered form, which restricts its practical application. To overcome this limitation, it is necessary to integrate ZIOS into a membrane substrate for enhanced functionality. Disclosed herein are novel adsorptive membranes capable of selective and effective capture of nickel and copper ions from water environment.

Controlling the morphology and orientation of the adsorbent on the membrane substrate is important for achieving adsorption and separation performance in membrane-based adsorption processes. It is important because it can impact the accessibility, binding capacity, and overall transport properties of the membrane, which can ultimately affect the separation performance in membrane-based adsorption processes. However, the control of crystal orientation, grain size as well as morphology, and intergrowth remains a major challenge. Often, the pathways from translating these micron-size particles into reliable and scalable membrane platforms are not straightforward if one was to pursue a membrane structure distinct from the typical mixed-matrix membrane platform.

Demonstrated herein are methods of fabricating novel adsorptive membranes governed by coordinative interactions to capture nickel ions and other transition metal ions. The membrane is based on a coordination built upon zinc metal nodes and imidazole and salicylaldoxime (co)ligands (ZIOS). In one non-limiting embodiment, the present disclosure is directed to the design and fabrication procedures for heavy metal cation-capturing membranes constructed from stacks of zinc imidazole salicylaldoxime nanosheets and polydopamine-polyethyleneimine-modified polyvinylidene fluoride (PVDF-PDA-PEI) as active compartment and supporting substrate, respectively. The dimensional and morphological textures of ZIOS layers can be tuned by varying the concentrations of poly(vinyl alcohol) (PVA, Mw=146,000-186,000 g/mol). The textural properties (e.g., morphology, size, particle orientation, and uniformity) and the adhesion to the supporting substrate of ZIOS-assembled layers can be achieved by manipulating the synthetic conditions, enabling kinetic reaction control. The synthesized ZIOS/PVDF-PDA-PEI membranes feature distinct ion transport and ion adsorption efficiency, which are significant factors for selective heavy metal ion capture, wherein the ZIOS layer functions as an active compartment to adsorptively separate transition metal cations.

Before further describing various embodiments of the present disclosure in more detail by way of exemplary description, examples, and results, it is to be understood that the compounds, compositions, and methods of present disclosure are not limited in application to the details of specific embodiments and examples as set forth in the following description. The description provided herein is intended for purposes of illustration only and is not intended to be construed in a limiting sense. As such, the language used herein is intended to be given the broadest possible scope and meaning, and the embodiments and examples are meant to be exemplary, not exhaustive. Also, it is to be understood that the phraseology and terminology employed herein is for the purpose of description only and should not be regarded as limiting unless otherwise indicated as so. In the description below, numerous specific details are set forth in order to provide a more thorough understanding of the present disclosure. However, it will be apparent to a person having ordinary skill in the art that the present disclosure may be practiced without these specific details. In other instances, features which are well known to persons of ordinary skill in the art have not been described in detail to avoid unnecessary complication of the description. It is intended that all alternatives, substitutions, modifications, and equivalents apparent to those having ordinary skill in the art are included within the scope of the present disclosure. Thus, while the compounds, compositions, and methods of the present disclosure have been described in terms of particular embodiments, it will be apparent to those of skill in the art that variations may be applied to the compounds, compositions, and methods and in the steps or in the sequence of steps of the methods described herein without departing from the concept, spirit, and scope of the inventive concepts.

Each patent, published patent application, and non-patent publication referenced in any portion of this application is expressly incorporated herein by reference in its entirety to the same extent as if the individual patent, or published patent application, or non-patent publication was specifically and individually indicated to be incorporated by reference.

Unless otherwise defined herein, scientific and technical terms used in connection with the present disclosure shall have the meanings that are commonly understood by those having ordinary skill in the art. Further, unless otherwise required by context, singular terms shall include pluralities and plural terms shall include the singular.

As utilized in accordance with the methods and compositions of the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or when the alternatives are mutually exclusive, although the disclosure supports a definition that refers to only alternatives and “and/or.” The use of the term “at least one” will be understood to include one as well as any quantity more than one, including but not limited to, 2, 3, 4, 5, 6, 7, 8, 9, 10, 15, 20, 30, 40, 50, 100, or any integer inclusive therein. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z.

As used herein, all numerical values or ranges include fractions of the values and integers within such ranges and fractions of the integers within such ranges unless the context clearly indicates otherwise. Thus, to illustrate, reference to a numerical range, such as 1-10 includes 1, 2, 3, 4, 5, 6, 7, 8, 9, 10, as well as 1.1, 1.2, 1.3, 1.4, 1.5, etc., and so forth. Reference to a range of 1-50 therefore includes 1, 2, 3, 4, 5, 6, 7, 8, 9, 10, 11, 12, 13, 14, 15, 16, 17, 18, 19, 20, etc., up to and including 50, as well as 1.1, 1.2, 1.3, 1.4, 1.5, etc., 2.1, 2.2, 2.3, 2.4, 2.5, etc., and so forth. Reference to a series of ranges includes ranges which combine the values of the boundaries of different ranges within the series. Thus, to illustrate reference to a series of ranges, for example, of 1-10, 10-20, 20-30, 30-40, 40-50, 50-60, 60-75, 75-100, 100-150, 150-200, 200-250, 250-300, 300-400, 400-500, 500-750, 750-1,000, includes ranges of 1-20, 10-50, 50-100, 100-500, and 500-1,000, for example.

As noted above, any numerical range listed or described herein is intended to include, implicitly or explicitly, any number or sub-range within the range, particularly all integers, including the end points, and is to be considered as having been so stated. For example, “a range from 1.0 to 10.0” is to be read as indicating each possible number, including integers and fractions, along the continuum between and including 1.0 and 10.0, that is, having a minimum value equal to or greater than 1.0 and a maximum value equal to or less than 10.0, such as, for example, 3.25 to 8.65. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. Thus, even if a particular data point within the range is not explicitly identified or specifically referred to, it is to be understood that any data points within the range are to be considered to have been specified, and that the inventor(s) possessed knowledge of the entire range and the points within the range.

As used in this specification and claims, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

Throughout this application, the terms “about” or “approximately” are used to indicate that a value includes the inherent variation of error for the composition, the method used to administer the composition, or the variation that exists among the study subjects. As used herein the qualifiers “about” or “approximately” are intended to include not only the exact value, amount, degree, orientation, or other qualified characteristic or value, but are intended to include some slight variations due to measuring error, manufacturing tolerances, observer error, and combinations thereof, for example. The term “about” or “approximately”, where used herein when referring to a measurable value such as an amount, a temporal duration, and the like, is meant to encompass, for example, variations of ±20% or ±10%, or ±5%, or ±1%, or ±0.1% from the specified value, as such variations are appropriate to perform the disclosed methods and as understood by persons having ordinary skill in the art. As used herein, the term “substantially” means that the subsequently described event or circumstance completely occurs or that the subsequently described event or circumstance occurs to a great extent or degree. For example, the term “substantially” means that the subsequently described event or circumstance occurs at least 80% of the time, at least 90% of the time, at least 91% of the time, at least 92% of the time, at least 93% of the time, at least 94% of the time, at least 95% of the time, at least 96% of the time, at least 97% of the time, at least 98% of the time, or at least 99% of the time.

As used herein any reference to “one embodiment” or “an embodiment” means that a particular element, feature, composition, structure, or characteristic described in connection with the embodiment is included in at least one embodiment. The appearances of the phrase “in one embodiment” in various places in the specification are not necessarily all referring to the same embodiment.

The term “wt %” (a.k.a., “wt/wt %” and “% (w/w)”) when used in reference to a solute is a measure of the concentration of a solute in a solution in terms of the mass of the solute and the mass of the solvent in which the solute is dissolved. The soluteₘₐₛₛ+the solventₘₐₛₛ=the solutionₘₐₛₛ. Wt % is calculated by dividing the soluteₘₐₛₛ by the solutionₘₐₛₛ, then multiplying the resulting quotient by 100.

The term “substrate” may also be used interchangeably herein with the term “membrane support.”

Zinc imidazole salicylaldoxime supermolecule (ZIOS) material is a type of hydrogen-bonded, organic-inorganic framework that comprises trinuclear units of zinc(II) and the organic compounds 2-methylimidazole and salicylaldoxime. The reaction of Zn(NO₃)₂, 2-methylimidazole (Hmim), and the copper chelator salicylaldoxime (H₂salox) in water (e.g., at around 55° C.) results in the formation of ZIOS. The material forms rapidly as small crystals in relatively high yield (76%) following the combination of separate mixtures of H₂salox/Zn(NO₃)₂ and H₂salox/mim. The ZIOS structure features Zn₃(H₂salox)₄(mim)₂ (i.e., Zn₃(C₆H₄CHNOHO)₄(CH₃C₃H₂N₂)₂) trinuclear units, wherein H₂salox and 2-methylimidazole are deprotonated and bonded directly to Zn²⁺ nodes through tetrahedral and pentahedral coordination by oxygen and nitrogen, respectively. Intermolecular hydrogen bonds between the hydroxyimino oxygen of H₂salox and the pyrrolic nitrogen of 2-methylimidazole lead to the formation of a two-dimensional supramolecular network. ZIOS adsorbs ˜98.0% of the copper(II), ˜93.9% of the Fe²⁺/Fe³⁺ and ˜92.2% of the Ni²⁺ in solution. The selectivity of ZIOS may be tuned by changing the solution pH. For example, when adsorption tests were carried out using metal ion solutions prepared with pH=2.45, copper uptake by ZIOS remained high (˜97.5%) while the material adsorbed negligible iron (˜14.3%) and nickel (˜2.9%).

The heavy metal cation-capturing membranes described herein may be prepared by depositing ZIOS onto a substrate (membrane support). Non-limiting examples of membrane supports that can be used to form the metal ion capture membranes described herein are provided in Table 1. In some aspects, the membrane supports comprises polyvinylidene fluoride (PVDF) that has been coated with polydopamine (PDA) and polyethyleneimine (PEI). Average pore size of the membrane support may be in a range of, for example, 0.01 μm to 5 μm. Particular examples of average pore sizes include but are not limited to 0.02 μm, 0.2 μm, 0.45 μm, 0.8 μm, 1.2 μm, and 3.0 μm.

TABLE 1
Non-limiting examples of membrane supports and pore sizes.

| No. | Support membranes | Exemplary Pore sizes (μm) |
|---|---|---|
| 1 | Polyvinylidene fluoride | 0.02, 0.2, 0.45, 0.8, 1.2, 3.0 |
| 2 | Polysulfone | 0.02, 0.2, 0.45, 0.8, 1.2, 3.0 |
| 3 | Polyethersulfone | 0.02, 0.2, 0.45, 0.8, 1.2, 3.0 |
| 4 | Polyacrylonitrile | 0.02, 0.2, 0.45, 0.8, 1.2, 3.0 |
| 5 | Cellulose acetate | 0.02, 0.2, 0.45, 0.8, 1.2, 3.0 |
| 6 | Cellulose triacetate | 0.02, 0.2, 0.45, 0.8, 1.2, 3.0 |
| 7 | Nylon | 0.02, 0.2, 0.45, 0.8, 1.2, 3.0 |
| 8 | Polyester | 0.02, 0.2, 0.45, 0.8, 1.2, 3.0 |

The methods may comprise incubating the membrane support with a solution comprising zinc nitrate hexahydrate, 2-methylimidazole, salicylaldoxime, and optionally a viscosity enhancer.

The methods may comprise incubating the membrane support between two cells, wherein the first cell comprises zinc nitrate hexahydrate and the second cell comprises 2-methylimidazole, salicylaldoxime, and optionally a viscosity enhancer.

In non-limiting embodiments, the concentration of zinc nitrate hexahydrate in the solution may be in a range of about 1 mM to about 30 mM, such as in a range of 4.4 mM to 17.4 mM. In non-limiting embodiments, the concentration of 2-methylimidazole in the solution may be in a range of about 10 mM to about 200 mM, such as in a range of 34.7 mM to 138.6 mM. In non-limiting embodiments, the concentration of salicylaldoxime in the solution may be in a range of about 10 mM to about 150 mM, such as in a range of 26.2 mM to 104.7 mM.

The incubation may be carried out, in non-limiting embodiments, for at least about 1 h to about 24 h. The incubation may be carried out, in non-limiting embodiments, at a temperature in a range of about 20° C. to about 60° C. For example, in a particular but non-limiting embodiment the incubation may be carried out for about 2 h at about 55° C.

Exemplary viscosity enhancers are provided in Table 2. When the viscosity enhancer is included the incubation, it may be present in the solution at a concentration of about 0.1% (w/w) to about 3% (w/w), such as for example, about 1% (w/w) to about 2% (w/w).

TABLE 2
Examples of viscosity enhancers potentially used to control
the ZIOS membrane morphology during synthesis.

| No. | Viscosity enhancers |
|---|---|
| 1 | Poly(vinyl alcohol) (PVA) |
| 2 | Poly ethylene glycol (PEG) |
| 3 | Polyvinylpolypyrrolidone (PVP) |
| 4 | Polyethyleneglycol lauryl ether (Brij 35) |
| 5 | Polyethylene glycol tert-octylphenyl ether (Triton X-100) |
| 6 | Cetrimonium bromide (CTAB) |
| 7 | 5-(tetradecyloxy)-2-furoic acid (TOFA) |
| 8 | Sodium dodecyl sulfate (SDS) |
| 9 | Scleroglucan |

The zinc imidazole salicylaldoxime supramolecule (ZIOS)-based membranes provided herein may have a hexagonal sheet morphology.

### EXAMPLES

Examples are provided hereinbelow. However, the present disclosure is to be understood as not limited in its application to the specific experimentation, results, and laboratory procedures disclosed below or elsewhere herein. Rather, each example is provided as one of various embodiments and the examples are meant to be exemplary, not exhaustive.

### Methods

PVDF membrane filter supports (membrane supports) with a diameter of 47 mm, a wall thickness of 125 μm and an average pore size of 0.22 μm were from Sterlitech (USA). PDA-PEI co-deposition process employed dopamine hydrochloride (MW of 189.64), PEI (MW of 800), and trizma base supplied by Sigma-Aldrich. For the ZIOS deposition process, zinc nitrate hexahydrate (Zn(NO₃)₂.6H₂O), 2-methylimidazole,salicylaldoxime, and poly(vinyl alcohol) (PVA, Mn=146,000-186,000 g/mol) were purchased from Sigma-Aldrich (USA). For the ion capture process, nickel(II) nitrate hexahydrate were purchased from Sigma-Aldrich (USA). All the chemicals were used without further treatment.

### Fabrication of a ZIOS/PVDF-PDA-PEI Membrane

Surface modification of the PVDF support: The bare PVDF membrane supports were modified using polydopamine (PDA) and polyethyleneimine (PET) based on the expectation for enhanced attachment of ZIOS seeds via H-bonding.

Surface modification of the PVDF membrane support by PDA-PEI co-deposition: First, the deposition solution was prepared by dissolving 778 mg trizma hydrochloride in mixture of EtOH and DI water ratio 1:9, followed by adding PEI and PDA to obtain 0.2 wt % PDA and 0.2 w % PEI deposition matrix. Then, the PVDF membrane supports were soaked in the deposition solution for 6 h under a shaking speed of 50 rpm. Afterwards, the membranes were rinsed with water three times to remove all the loosely attached chemicals and dried in vacuum oven at room temperature overnight.

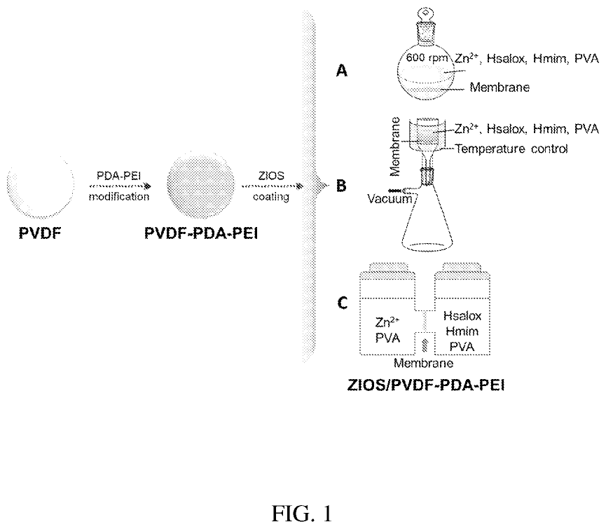

ZIOS/PVDF-PDA-PEI synthetic methodology: ZIOS/PVDF-PDA-PEI membranes were fabricated by in-situ synthesis of ZIOS on PVDF-PDA-PEI membrane. A schematic of the process is demonstrated in FIG. 1. ZIOS/PVDF-PDA-PEI membranes synthesized by (i) in-solution hydrothermal growth method (ZIOS/PVDF-PDA-PEI (Method A)), (ii) vacuum-assisted growth method (ZIOS/PVDF-PDA-PEI (Method B)) and (iii) Interfacial growth method (ZIOS/PVDF-PDA-PEI (Method C)).

In-solution hydrothermal growth (Method A): PVA was first dissolved in DI water at 80° C. with reflux to prepare 1 wt % PVA solution. After the solution cooled down to room temperature, the modified PVDF membrane was immersed into the ZIOS deposition solution. The deposition solution contained PVA 1% solution of 0.222 g of zinc nitrate hexahydrate, 0.489 g of 2-methylimidazole and 0.623 g of salicylaldoxime in 43 ml DI water. The mixture was stirred for 2 h at around 55° C. After the deposition process, the membrane was rinsed with water and methanol, followed by drying at room temperature for 24 h. The membrane synthesized by the in-solution hydrothermal growth method is designated as ZIOS/PVDF-PDA-PEI (Method A).

In this work, ZIOS in-situ growth on the PVDF-PDA-PEI membrane by in-solution hydrothermal growth method in the absence of PVA was also conducted as a comparison.

Vacuum-assisted growth (Method B): PVDF-PDA-PEI was utilized as a membrane support. The vacuum holder was covered by fabric heating mantle, which was equipped with an externally powered temperature controller (CN 4116 022013A). Once the holder reached 55° C., a mixture of 0.623 g/20 mL salicylaldoxime, 0.489 g/20 mL MeIM, and 0.222 g/3 mL Zn(NO₃)₂.6H₂O were added. The reaction proceeded undisturbed at 55° C. for 2 h. Subsequently, the vacuum was switched on to remove any residual reactant, and the product was washed twice with DI water and methanol. Finally, the ZIOS/PVDF-PDA-PEI was vacuum-dried at room temperature for 24 h. The membrane synthesized by vacuum-assisted growth is designated as ZIOS/PVDF-PDA-PEI (Method B).

Interfacial growth (Method C): The membrane synthesized by interfacial growth method using an interfacial reaction and crystallization process that occurred at the interface between two immiscible cells. The first cell contained 0.222 g of zinc nitrate hexahydrate, while the second cell contained a mixture of 0.489 g of 2-methylimidazole and 0.623 g of salicylaldoxime in a 10 mL 1% PVA solution. The solution in each cell was continuously stirred and the reaction was carried out for 2 h at 55° C. using water jacket maintained with a cooling/heating recirculator. The continuous layer of crystalline ZIOS was isolated and obtained as a free-standing layer on PVDF-PDA-PEI support. After deposition, the membrane was rinsed with water and methanol, before being dried at room temperature for 24 h. The membrane synthesized by interfacial growth is designated as ZIOS/PVDF-PDA-PEI (Method C).

### Nickel Ion Capture Experimental Apparatus

The ion capture experiment was performed using side-by-side horizontal type diffusion cells, comprised of feed and receiving half-cell compartments equipped with water jackets. The feed compartment initially contained the target ion, whereas the receiving compartment held DI water. The ZIOS/PVDF-PDA-PEI membranes (1.5 cm² active area) were clamped between the donor and receptor compartment. Subsequently, an amount of 12 mL of Ni²⁺ 10 ppm (pH=5.0) was placed in feed compartment, and the receiving solution contained 12 mL of DI water. Each chamber was continuously stirred with a stir bar at room temperature. At defined time intervals, 0.5 mL of the solution in the feed compartment was taken and diluted with HNO₃ 2%. The samples were analyzed using the ICP-OES analytical method to quantify concentrations of Ni²⁺. The experiment was repeated three times.

To determine the effect of pH on the adsorption of Ni²⁺ onto ZIOS/PVDF-PDA-PEI membrane, the same analysis was conducted using a similar initial solution, but the pH was adjusted to 2.5 by adding HCl 0.1M.

### Multi-Component Ions Adsorption/Separation Experimental Apparatus

An equimolar ionic solution containing Cu²⁺, Cu²⁺, Ni²⁺, Co²⁺ and Mn² at a concentration of approximately 10 ppm was prepared. The solution comprised 12 mL of the equimolar ionic solution, which was added to the feed compartment, and 12 mL of deionized (DI) water in the receiving solution compartment. Both compartments were continuously stirred with a stir bar at room temperature. At defined time intervals, 0.5 mL of the solution in the feed compartment was sampled and diluted with 2% HNO₃. The diluted samples were then analyzed using the ICP-OES analytical method to determine the concentrations of Cu²⁺, Cu²⁺, Ni²⁺, Co²⁺ and Mn²⁺. The initial pH of the stock mixture ion solution in the feed compartment was 5.0. The experiment was repeated three times.

To investigate the influence of pH on the adsorption and separation of multi-component ions on the ZIOS/PVDF-PDA-PEI membrane, a similar analysis was conducted using an identical initial solution including Cu²⁺, Cu²⁺, Ni²⁺, Co²⁺ and Mn²⁺, but the pH was adjusted to 2.5, 5.0, or 8.0 by adding 0.1M HCl or 0.05M NaOH accordingly.

### Characterizations

SEM and EDX analysis were performed using a Thermo Scientific™ Quattro ESEM. PXRD patterns were obtained by a focused-beam Cu K_{α} radiation (K_{α}=1.541 Å) at a continuous scan of step width 0.01° and count time of 2 s/step in the range of 5-45°. A simulated PXRD pattern of ZIOS was calculated from single-crystal X-ray diffraction data using a Mercury 3.3 program. FT-IR was carried out using Thermo Scientific Nicolet iS50R at a continuous scan in the range from 4000 to 400 cm⁻¹. Raman spectra are obtained using a Renishaw inVia high resolution Raman microscope equipped with a 532 nm solid-state laser source. Inductively Coupled Plasma Optical Emission spectroscopy (ICP-OES, Thermo Scientific iCap Pro) was used to measure ion concentration in solution samples.

### Results

### Fabrication of ZIOS/PVDF-PDA-PEI Membrane

The growth of ZIOS on PDA/PEI-modified PVDFmembrane supports to produce ZIOS/PVDF-PDA-PEI membranes is schematically illustrated in FIG. 1. The PVDF substrate was initially functionalized with PDA and PEI, which act as a primer layer based on the expectation for enhanced adhesion of ZIOS seeds to the membrane surfaces via their interactive H-bonding networks. For the subsequent deposition of ZIOS onto the modified PVDF, several important factors should be noted throughout the membrane fabrication, i.e., ZIOS density and adhesion to PVDF substrate, growth kinetic, and scalability. Herein, the morphology of ZIOS was controlled by PVA concentration, and ZIOS/PVDF-PDA-PEI membrane fabrication process was carried out through three different methods, including in-solution hydrothermal growth, vacuum-assisted growth (method B), and diffusional growth (Method C).

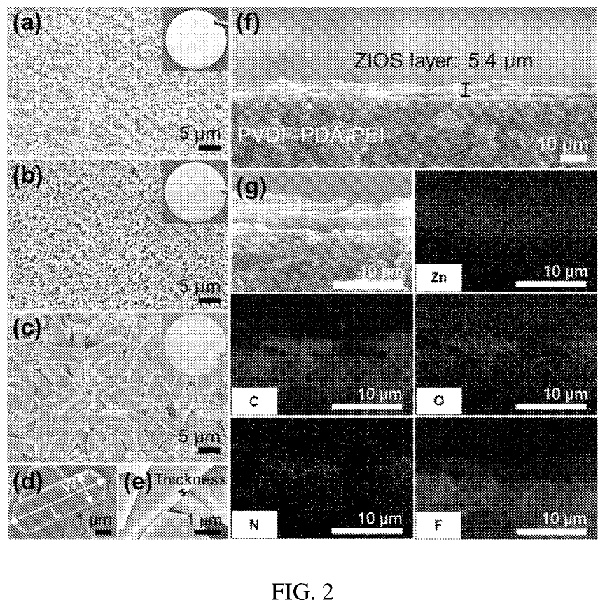

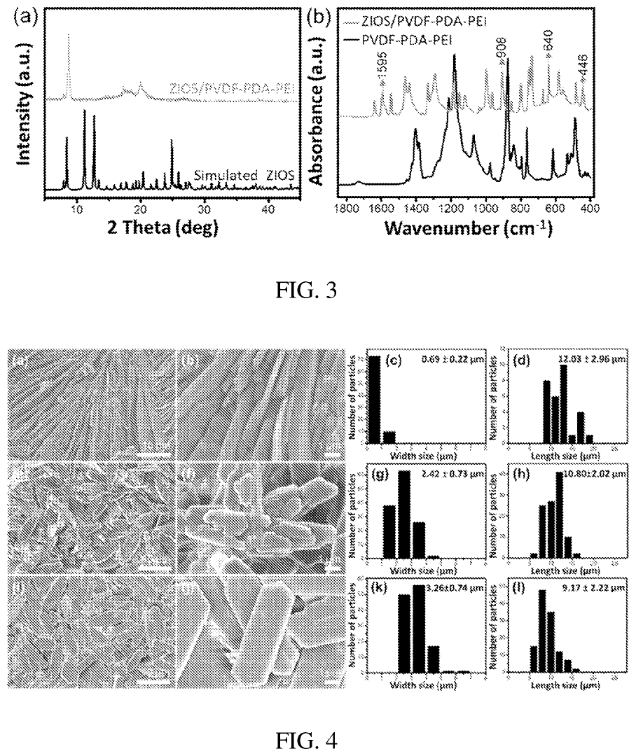

In-solution hydrothermal growth (Method A): Among the various synthetic methods, the stirring-assisted hydrothermal method also known as in-solution hydrothermal growth method is a particularly promising option. By introducing stirring force during the hydrothermal process, this method offers the benefits of enhancing product uniformity and morphology through uniform mixing during the reaction process. Hence, the inventors developed a strategy to synthesize based on the magnetic-stirring assisted hydrothermal method. The prepared PVDF-PDA-PEI substrate was subjected to the growth of ZIOS in a condition at 55° C. for 2 h. The obtained membrane is denoted as ZIOS/PVDF-PDA-PEI (Method A). As seen from inserted digital camera images (FIG. 2a-b), the photographs indicate color tuning of the membrane from white to brown after PDA-PEI co-deposition which is attributed to the successful deposition of PDA. FIG. 2a shows the surface morphologies of pristine PVDF membrane with a porous and uniform surface. The membrane surface exhibits similar morphologies compared to pristine PVDF no obvious PDA aggregations are observed (FIG. 2b). We hypothesize that PEI might effectively reduce the non-covalent interactions among the PDA fragments and prevent the enlargement of PDA aggregations. Then the deposition of ZIOS on the pre-modified PVDF-PDA-PEI substrate was achieved by soaking the membrane within a solution contained zinc nitrate hexahydrate and 2-methylimidazole (ZIOS/PVDF-PDA-PEI). FIG. 2c-e demonstrates that stacks of ZIOS nanosheets with a high degree of size and morphological monodispersity were well-synthesized. The dimensional textures of ZIOS nanosheets are estimated to be 9.2×3.3×0.5 μm (L×W×H). Importantly, the ZIOS growth using method A achieved a high degree of surface coverage in a short period, suggesting that it can be readily scaled up for practical applications. The fact that all reagents used for the synthesis are environmentally benign is important to practical applications. Energy-dispersive X-ray (EDX) further confirmed the uniform distribution of Zn, C, O, N and F (FIG. 3e). Zn, C, O, and N were the primary components of ZIOS, while F came from the PVDF substrate. This suggests that the deposition of ZIOS on the PVDF membrane support was successful.

The crystallinity of ZIOS/PVDF-PDA-PEI (Method A) was investigated using powder X-ray diffraction (PXRD) and it was found that the PXRD pattern of ZIOS/PVDF-PDA-PEI (Method A) is very similar to that of simulated ZIOS (FIG. 3a). The XRD results confirms most of the major peaks exhibited by simulated ZIOS patterns. FT-IR was measured to investigate the chemical bonds in the membrane before and after ZIOS coating (FIG. 3b). Compared with the PVDF-PDA-PEI membrane, the ZIOS/PVDF-PDA-PEI membrane has different characteristic adsorption peaks. After the deposition of ZIOS, there are several new bands belong to characteristic of ZIOS were observed. FTIR spectra reveal the existence of characteristic peaks at 444 cm⁻¹ and 640 cm⁻¹, which correspond to Zn—N and Zn—O stretching vibrational modes, respectively. The vibrational modes of the characteristic ligand units (C═N stretch at 1595 cm⁻¹ and N—O at 908 cm⁻¹) were observed. The corresponding FTIR reveals the appearance of vibrational bands characteristic of ZIOS after the coating process as a confirmation of successful growth of ZIOS on the membrane support.

The morphology of ZIOS can be modified by the addition of PVA. We employed PVA solutions with different concentrations (0%, 0.5%, and 1%) to investigate the effect of PVA addition on the morphologies of ZIOS growth on PVDF-PDA-PEI membrane. FIG. 4 illustrates that as the PVA concentration increases from 0% to 1%, the width of ZIOS expands from 0.69 μm to 3.26 μm, while the length of ZIOS decreases from 12.03 μm to 9.17 μm. Consequently, a transformation from a rod-like to a hexagonal sheet-like morphology is observed. PVA polymer additive was used as viscosity enhancer, which can play an important role in nanoparticle morphology because of the competition of the reactants between other reactants and the additives. It is speculated that it may be a result of PVA chains attaching to the surface of small crystals, possibly through interactions between the dangling Zn center and OH groups, which could hinder growth among certain directions, leading to the transformation from rod-like to hexagonal sheet-like morphology. It can be seen that rod morphology may show lower surface coverage than hexagonal sheet morphology. One possible explanation for this phenomenon could be the packing density of the materials. Rod-like structures may have a more disordered and loosely packed arrangement, which can result in rough surface and lower surface coverage. Hexagonal sheet structure, on the other hand, have a more ordered and tightly packed arrangement, which can lead to a higher surface coverage on the substrate. In addition, the denser and more compact structure of sheet morphologies and their ability to promote laminar flow, might be helpful to reduce the risk of fouling and improve the performance of a membrane compared to rod-like shapes. Therefore, a constant parameter of adding PVA was maintained to further examine the growth direction of ZIOS on PVDF-PDA-PEI substrates.

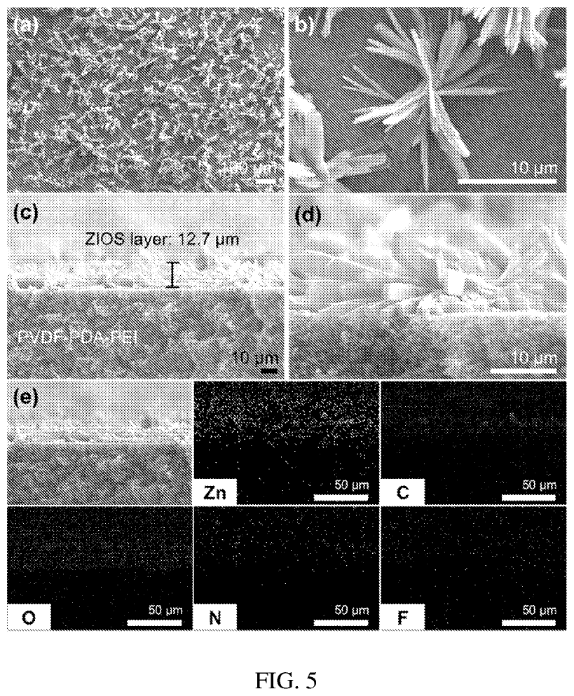

Vacuum-assisted growth (Method B): Effective initialization and control of nucleation is essential during the coating process, and vacuum-assisted growth has emerged as a potential technique for achieving this goal. The vacuum was employed to direct the growth of ZIOS hexagonal sheet toward the surface of PVDF-PDA-PEI substrate (membrane support) and to improve the ZIOS adhesion to the substrate. The morphology of ZIOS particles grown on the as-prepared PVDF-PDA-PEI through Method B ((ZIOS/PVDF-PDA-PEI (Method B)) is shown in FIG. 5. FIGS. 5a, b indicate that the ZIOS hexagonal sheets were self-assembled into a small cluster and successfully grown onto the substrate; however, with a low degree of surface coverage. Cross-section SEM (FIG. 5c,d) show that the ZIOS layer thickness is around 12.7 μm. FIG. 5e demonstrates EDX mapping as further confirmation of the successful deposition of the ZIOS layer. It appears that the nucleation density on the PVDF-PDA-PEI support surface was not enough to allow a continuous ZIOS film. In addition, the vacuum-assisted growth method under gravity favors growth along the vertical direction and ZIOS sheet possess self-assembled flowerlike architectures.

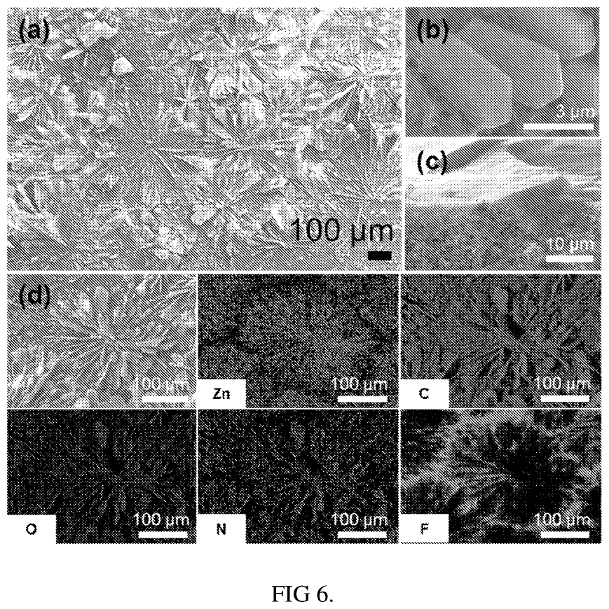

Interfacial growth (Method C): The growth of ZIOS on the PVDF-PDA-PEI substrate can be controlled by slowly diffusing separated reactant solutions through the porous PVDF-PDA-PEI substrate, on which the growth of ZIOS occurs as the reactants come into contact at the solid/liquid interfaces. This implies a major advantage in improving the adhesion, stability, as well as thickness control of the resulting membrane. Continuous films with highly crystalline domains of ZIOS were produced using a combined interfacial condensation reaction and crystallization process at an interface. This interfacial process allows the reaction of ZIOS, which is synthesized via a reaction between zinc ions and mixture of 2-methylimidazole and salicylaldoxime ligands, while simultaneously directing the formation of ZIOS films at the interface. FIG. 6a demonstrates the resulting ZIOS layer grown on the PVDF-PDA-PEI substrate by Method C (ZIOS/PVDF-PDA/PEI (Method C)). High magnified SEM images (FIG. 6b, c) show that the ZIOS layer is composed of plethora of hexagonal sheets (L 5.0×W 3.3×H 0.3 μm). The successful deposition of ZIOS layer was further confirmed by EDX mapping (FIG. 6d). It can be seen that there were two factors contributing to the particular orientation of ZIOS growth on membrane support. First, there is a sufficient nucleation density on the membrane support, assisting in the orientation of ZIOS growth. Secondly, the addition of a PVA viscosity enhancer plays a role in shaping the morphology of ZIOS. Among the three synthesis approaches, ZIOS/PVDF-PDA/PEI (Method A) synthesized by in-solution hydrothermal growth exhibited the most even coating and the fewest defects compared to ZIOS/PVDF-PDA/PEI (Method B) synthesized by vacuum-assisted growth and ZIOS/PVDF-PDA/PEI (Method C) synthesized by interfacial growth. The novel feature of this approach is its ability to produce a high-quality coating with minimal defects, which can improve the nickel ion adsorption performance of the membrane.

### Ni²⁺ Adsorption Behaviors of the ZIOS/PVDF-PDA-PEI Membrane

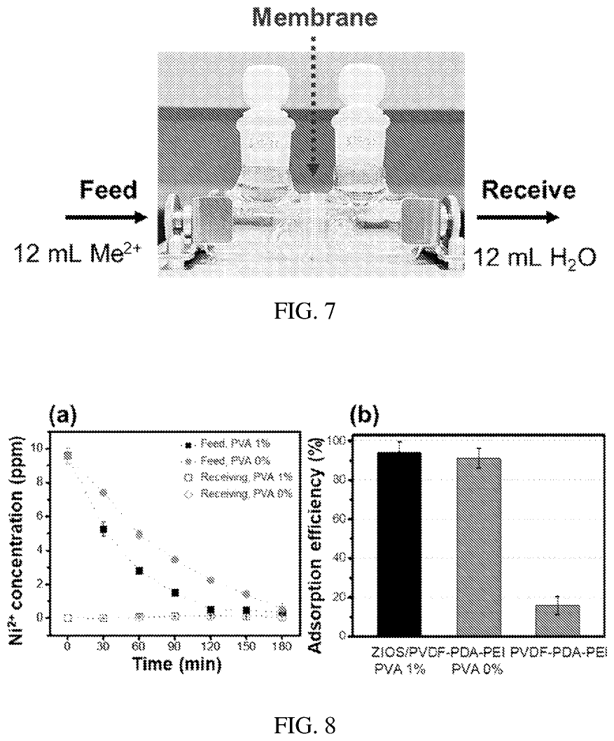

The controllable morphology and orientation of ZIOS growth on PVDF-PDA-PEI substrate play a very important role in adsorption behavior of the membrane. ZIOS/PVDF-PDA-PEI membranes were tested in the side-by-side horizontal diffusion cells as illustrated in FIG. 7.

### Effects of PVA on Ni²⁺ Ion Removal Performance

Controlling the morphology of adsorbent growth on a substrate can allow for more precise tuning of these properties, which can lead to improved adsorption performance. In this regards, ZIOS/PVDF-PDA-PEI membrane synthesized in the presence of PVA 1% solution with hexagonal sheet-like morphology and ZIOS/PVDF-PDA-PEI membrane synthesized in the absence of PVA solution with rod-like morphology were tested for the capture of Ni²⁺ from feed solutions containing 10 ppm Ni²⁺. As shown in FIG. 8a, the nickel ion concentration in the feed solution was reduced faster by the ZIOS/PVDF-PDA-PEI membrane synthesized with PVA 1% than by using a membrane synthesized in the absence of PVA solution. Both types of membranes showed comparable nickel ion permeation into the receiving solution. The ZIOS/PVDF-PDA-PEI membrane synthesized in the presence of PVA 1% achieved the nickel adsorption efficiency of 94.38%, which is higher than that of PVA-free ZIOS membrane, i.e., 91.11%, after 180 minutes (FIG. 8b). This might be explained due to the greater ZIOS coverage on the substrate surface with the inclusion of PVA, making more accessible sites for Ni²⁺ adsorption. Meanwhile, the Ni²⁺ capture efficiency of PVDF-PDA-PEI substrate without ZIOS is only 15.87%, emphasizing the significant role of ZIOS in the effective capture of nickel ions in the control test.

Ni²⁺ Adsorption Performance of ZIOS/PVDF-PDA-PEI Membranes Fabricated with Different Methods (Methods A, B, and C)

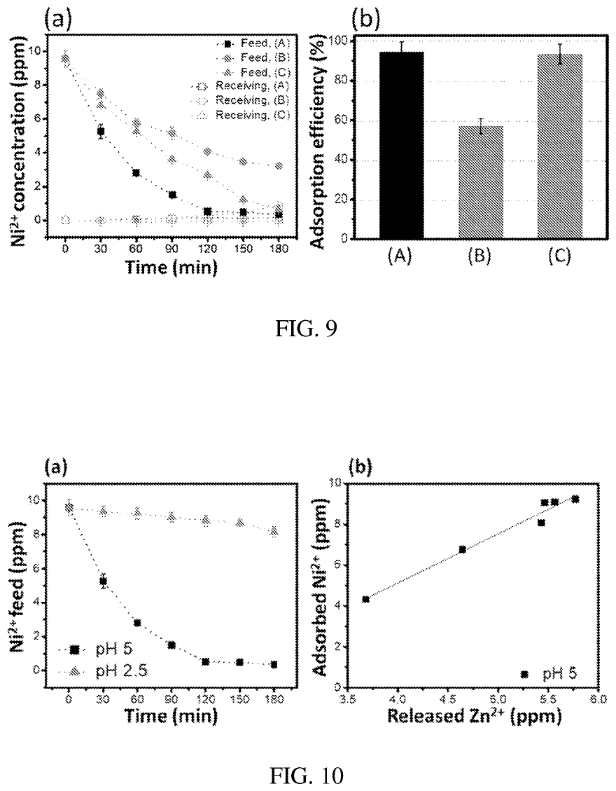

The orientation of adsorbent grown on the membrane plays a role in ion adsorption applications. In FIG. 9a, b, ZIOS/PVDF-PDA-PEI (Method A) prepared via in-solution hydrothermal growth presents the highest nickel ion capture performance of 94.38% after 30 minutes, followed by ZIOS/PVDF-PDA-PEI (Method C) prepared via interfacial growth (93.51%) and ZIOS/PVDF-PDA-PEI (Method B) prepared via vacuum-assisted growth (56.98%) after 30 minutes. Obviously, ZIOS/PVDF-PDA-PEI (Method A) and ZIOS/PVDF-PDA-PEI (Method C) are capable of holding nickel ions; meanwhile, the greater number of defects observed in ZIOS/PVDF-PDA-PEI (Method B) are likely to allow nickel ions to easily pass through the membrane. Among three means of synthesis, ZIOS/PVDF-PDA-PEI (Method A) synthesized through in-solution hydrothermal method has the most even coating with the fewest defects, marking it as the most appropriate candidate for nickel ion capture applications.

### Ni²⁺ Adsorption Performance of ZIOS/PVDF-PDA-PEI at Different pH

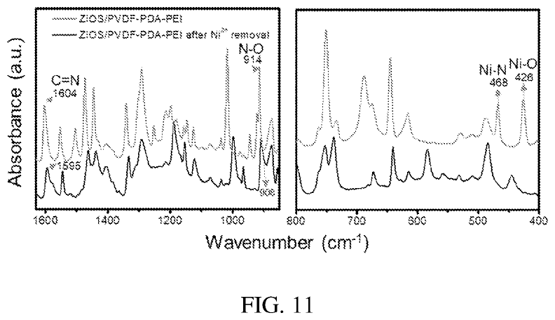

The adsorption of nickel ions onto the ZIOS adsorbent is significantly influenced by the pH level of the aqueous solution. To investigate this effect, the nickel ion adsorption was evaluated under pH values of 2.5 and 5.0. The results presented in FIG. 10 demonstrate that the adsorption behavior of the ZIOS/PVDF-PDA-PEI membrane can be tuned by changing the pH of the solution. Specifically, the removal performance of nickel ions decreased considerably under a lower pH environment (FIG. 10a). The relationship between the amount of adsorbed Ni²⁺ ion and released Zn²⁺ ion at pH 5.0 is depicted in FIG. 10b. This phenomenon can be explained by the change in solution pH leading to a favorable environment for coordination and ion exchange between ZIOS and nickel ions. Notably, the adsorption behavior of the ZIOS/PVDF-PDA-PEI membrane at a lower pH value (e.g., 2.5) holds promise for ion separation applications. It can be seen that ion exchange mechanism where nickel ion come to replace zinc ion of ZIOS of membrane. In addition, salicylaldoxime and 2-methylimidazole component of ZIOS participate in ligand coordination mechanism. Adsorption of Ni(II) on ZIOS/PVDF-PDA-PEI membrane was further probed with FT-IR. As shown in FIG. 11, the observed shift in the band of N—O in C═N—O—Ni toward higher energies (from 908 cm⁻¹ to 914 cm⁻¹) and the shift in the band of C—N toward higher energies (from 1595 cm⁻¹ to 1601 cm⁻¹) confirm their contribution of nickel in complexation. In addition, new adsorption bands for ZIOS/PVDF-PDA-PEI after Ni²⁺ ion removal were observed at 468 cm⁻¹ and 426 cm⁻¹, which were attributed to the characteristic band of Ni—N and Ni—O, respectively.

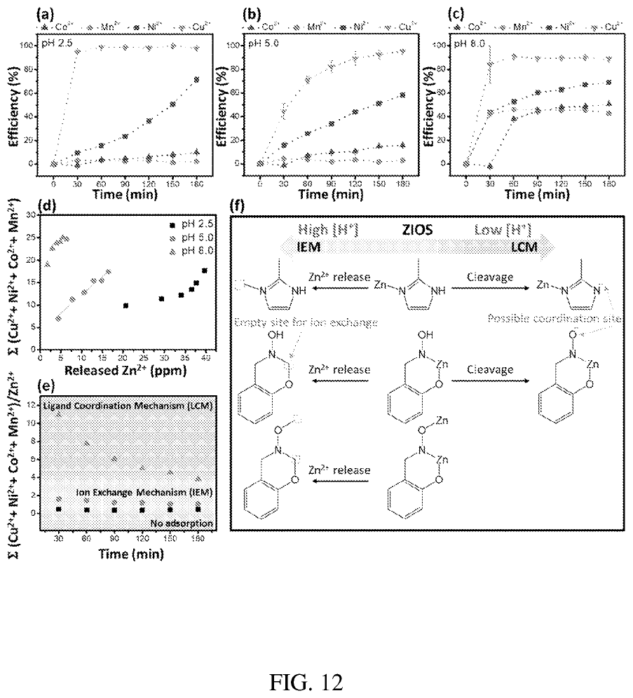

FIGS. 12a-12c illustrate the metal ion separation at different pH values (2.5, 5.0, and 8.0). Cu²⁺ exhibits efficient adsorption and separation initially, followed by Ni²⁺. Co²⁺ and Mn²⁺, on the other hand, are preferentially adsorbed under basic conditions. In FIG. 12(d, e), the correlation between the total concentrations of removed cations (i.e., Cu²⁺, Cu²⁺, Ni²⁺, Co²⁺ and Mn²⁺) and released Zn²⁺ concentrations over time is displayed. A ratio close to 1 suggests an ion exchange mechanism, as Ni, Cu, and Zn share the same oxidation state (II). We hypothesize that the dominant mechanism at low pH values is ligand coordination, and once the ligand adsorption site becomes saturated, the ion exchange mechanism takes over (ligand coordination mechanism and ion exchange mechanism occur simultaneously). When the environment has a high concentration of [H⁺] ions (e.g., at pH 2.5), the preferential release of Zn²⁺ takes place, leading to the formation of vacant sites for ion exchange. Conversely, under low [H⁺] conditions (e.g., at pH 8), cleavage is more likely to occur, resulting in the creation of additional coordination sites such as the N- of 2-methylimidazole or the O- of salicylaldoxime (FIG. 12f).

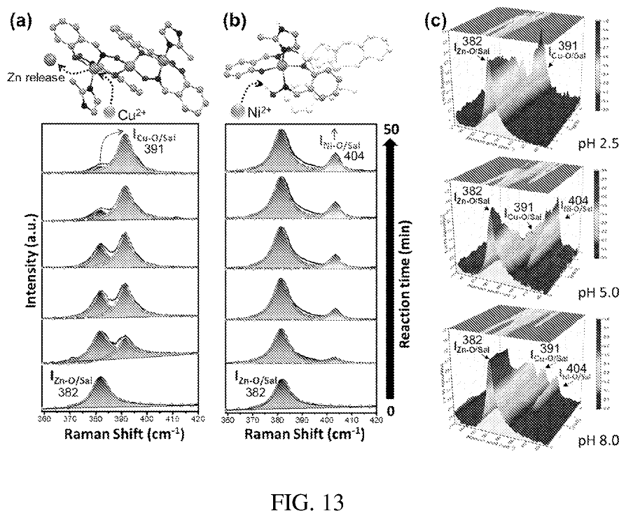

FIG. 13(a, b) illustrate the difference in the adsorption mechanisms of Cu²⁺ and Ni²⁺ through in-situ Raman analysis. During Cu²⁺ adsorption, the peak at 382 cm⁻¹ (characteristic of ZIOS) gradually decreases and eventually disappears, along with the evolution of the peak at 391 cm⁻¹ (characteristic of Cu-adsorbed ZIOS). In contrast, during Ni²⁺ adsorption, the peak at 404 cm⁻¹ (indicative of Ni-adsorbed ZIOS) increases, while the peak at ˜382 cm⁻¹ (representing ZIOS) remains unchanged. The results indicate that Cu²⁺ exhibits both ion exchange and ligand coordination mechanisms, whereas Ni²⁺ shows ligand coordination as the dominant mechanism. Additionally, ZIOS exhibits high ion selectivity towards Cu²⁺, Ni²⁺, Co²⁺ and Mn²⁺ at pH 2.5. (FIG. 13c).

### CONCLUSIONS

The present disclosure demonstrates approaches to controllably translate three-dimensional supramolecular crystals to adsorptive membranes to generate thin-film inorganic-organic composite (TFioC) membranes promising for effective metal ion recovery. In a non-limiting embodiment, the fabricated TFioC membranes are composed of an adsorptive (selective) layer of ZIOS crystalline sheets grown on a functionalized membrane support (e.g., PVDF) which is pretreated with polydopamine (PDA) and polyethyleneimine (PEI). In-solution hydrothermal growth, vacuum-assisted growth and interfacial growth methods have been optimized to prepare preferentially oriented and intergrown ZIOS on PVDF-PDA-PEI support. This investigation into three synthesis methods revealed that ZIOS/PVDF-PDA/PEI obtained through in-solution hydrothermal growth (Method A) had the most uniform coating and the least number of defects, making it the most suitable option for not only nickel capture but also for other metal ion separation (e.g., Ni²⁺, Cu²⁺, Co²⁺ or Mn²⁺) applications. A noteworthy feature of this technique is its potential to produce a high-quality coating with minimal defects, which can improve the ion adsorption performance of the membrane.

In view of the above, the present disclosure is directed to at least the following embodiments:

1. A method of preparing a metal cation-capturing membrane, the method comprising depositing a zinc imidazole salicylaldoxime supramolecule (ZIOS) onto a membrane support.
2. The method of 1, wherein the membrane support is selected from the group consisting of polyvinylidene fluoride (PVDF), polysulfone, polyethersulfone, polyacrylonitrile, cellulose acetate, cellulose triacetate, nylon, and polyester.
3. The method of 1 or 2, wherein the membrane support has a pore size in a range of about 0.01 μm to about 3 μm.
4. The method of any one of 1-3, wherein the membrane support comprises polyvinylidene fluoride that has been coated with polydopamine (PDA) and polyethyleneimine (PEI).
5. The method of any one of 1-4, wherein the method comprises incubating the membrane support with a solution comprising zinc nitrate hexahydrate, 2-methylimidazole, salicylaldoxime, and optionally a viscosity enhancer.
6. The method of any one of 1-4, wherein the method comprises incubating the membrane support between two cells, wherein the first cell comprises zinc nitrate hexahydrate and the second cell comprises 2-methylimidazole, salicylaldoxime, and optionally a viscosity enhancer.
7. The method of 5 or 6, wherein the incubation is carried out for a period of time in a range of about 1 h to about 24 h, and at a temperature in a range of about 20° C. to about 60° C. for about 2 h, at about 55° C.
8. The method of 5 or 6, wherein the incubation is carried out for a period of time of about 2 h, at a temperature of about 55° C.
9. The method of any one of 5-8, wherein the viscosity enhancer is selected from the group consisting of poly(vinyl alcohol) (PVA), poly ethylene glycol (PEG), polyvinylpolypyrrolidone (PVP), polyethyleneglycol lauryl ether (Brij 35), polyethylene glycol tert-octylphenyl ether (Triton X-100), cetrimonium bromide (CTAB), 5-(tetradecyloxy)-2-furoic acid (TOFA), sodium dodecyl sulfate (SDS), and scleroglucan.
10. The method of 9, wherein the viscosity enhancer is PVA.
11. The method of any one of 5-10, wherein the viscosity enhancer is present in the solution at a concentration in a range of about 0.1 wt. % to about 2 wt. %.
12. A metal cation-capturing membrane, comprising a zinc imidazole salicylaldoxime supramolecule (ZIOS) nanosheet deposited on a membrane support.
13. The metal cation-capturing membrane of 12, wherein the metal cation-capturing membrane is made by the method of any one of 1-11.
14. The metal cation-capturing membrane of 12 or 13, wherein the membrane support is selected from the group consisting of polyvinylidene fluoride, polysulfone, polyethersulfone, polyacrylonitrile, cellulose acetate, cellulose triacetate, nylon, and polyester.
15. The metal cation-capturing membrane of any one of 12-14, wherein the membrane support has a pore size in a range of about 0.01 μm to about 3 μm.
16. The metal cation-capturing membrane of any one of 12-15, wherein the membrane support comprises polyvinylidene fluoride that has been coated with polydopamine (PDA) and polyethyleneimine (PEI).
17. The metal cation-capturing membrane of any one of 12-16, wherein the ZIOS nanosheet has a hexagonal sheet morphology.
18. A method of removing transition metal ions from an aqueous solution, the method comprising passing the aqueous solution across the metal cation-capturing membrane of any one of 12-17.
19. The method of 18, wherein the aqueous solution comprises wastewater, brine, or mine drainage.
20. The method of 18 or 19, wherein the aqueous solution has a pH in a range of about 2.5 to about 8.
21. The method of any one of 18-20, wherein the transition metal ions comprise at least one of Ni, Cu, Mn, and Co ions.
22. The method of any one of 18-21, wherein in-situ Raman analysis is used to differentiate Cu²⁺ and Ni²⁺ adsorption mechanisms onto the metal cation-capturing membrane.

While the present disclosure has been described herein in connection with certain embodiments so that aspects thereof may be more fully understood and appreciated, it is not intended that the present disclosure be limited to these particular embodiments. On the contrary, it is intended that all alternatives, modifications and equivalents are included within the scope of the present disclosure as defined herein. Thus the embodiments described above, which include particular embodiments, will serve to illustrate the practice of the inventive concepts of the present disclosure, it being understood that the particulars shown are by way of example and for purposes of illustrative discussion of particular embodiments only and are presented in the cause of providing what is believed to be the most useful and readily understood description of methods and procedures as well as of the principles and conceptual aspects of the present disclosure. Changes may be made in the formulation of the various compositions described herein, the methods described herein or in the steps or the sequence of steps of the methods described herein without departing from the spirit and scope of the present disclosure.

1. A method of preparing a metal cation-capturing membrane, the method comprising depositing a zinc imidazole salicylaldoxime supramolecule (ZIOS) onto a membrane support.

2. The method of claim 1, wherein the membrane support is selected from the group consisting of polyvinylidene fluoride (PVDF), polysulfone, polyethersulfone, polyacrylonitrile, cellulose acetate, cellulose triacetate, nylon, and polyester.

3. The method of claim 1, wherein the membrane support has a pore size in a range of about 0.01 μm to about 3 μm.

4. The method of claim 1, wherein the membrane support comprises polyvinylidene fluoride that has been coated with polydopamine (PDA) and polyethyleneimine (PEI).

5. The method of claim 1, wherein the method comprises incubating the membrane support with zinc nitrate hexahydrate, 2-methylimidazole, salicylaldoxime in one or more solutions, and optionally a viscosity enhancer.

6. The method of claim 5, wherein the method comprises incubating the membrane support between two cells, wherein the first cell comprises zinc nitrate hexahydrate and the second cell comprises 2-methylimidazole, and salicylaldoxime.

7. The method of claim 5, wherein the incubation is carried out for a period of time in a range of about 1 h to about 24 h, and at a temperature in a range of about 20° C. to about 60° C. for about 2 h, at about 55° C.

8. The method of claim 5, wherein the incubation is carried out for a period of time of about 2 h, at a temperature of about 55° C.

9. The method of claim 5, wherein the viscosity enhancer is selected from the group consisting of poly(vinyl alcohol) (PVA), poly ethylene glycol (PEG), polyvinylpolypyrrolidone (PVP), polyethyleneglycol lauryl ether (Brij 35), polyethylene glycol tert-octylphenyl ether (Triton X-100), cetrimonium bromide (CTAB), 5-(tetradecyloxy)-2-furoic acid (TOFA), sodium dodecyl sulfate (SDS), and scleroglucan.

10. The method of claim 5, wherein the viscosity enhancer is PVA.

11. The method of claim 5, wherein the viscosity enhancer is present in the solution at a concentration in a range of about 0.1 wt. % to about 2 wt. %.

12. A metal cation-capturing membrane, comprising a zinc imidazole salicylaldoxime supramolecule (ZIOS) nanosheet on a membrane support.

13. The metal cation-capturing membrane of claim 12, wherein the metal cation-capturing membrane is made by depositing the ZIOS onto the membrane support.

14. The metal cation-capturing membrane of claim 13, wherein the method comprises incubating the membrane support with zinc nitrate hexahydrate, 2-methylimidazole, salicylaldoxime in one or more solutions, and optionally a viscosity enhancer.

15. The metal cation-capturing membrane of claim 12, wherein the membrane support is selected from the group consisting of polyvinylidene fluoride, polysulfone, polyethersulfone, polyacrylonitrile, cellulose acetate, cellulose triacetate, nylon, and polyester.

16. The metal cation-capturing membrane of claim 12, wherein the membrane support has a pore size in a range of about 0.01 μm to about 3 μm.

17. The metal cation-capturing membrane of claim 12, wherein the membrane support comprises polyvinylidene fluoride that has been coated with polydopamine (PDA) and polyethyleneimine (PEI).

18. The metal cation-capturing membrane of claim 12, wherein the ZIOS nanosheet has a hexagonal sheet morphology.

19. A method of removing transition metal ions from an aqueous solution, the method comprising passing the aqueous solution across the metal cation-capturing membrane of claim 12.

20. The method of claim 19, wherein the aqueous solution comprises wastewater, brine, or mine drainage.

21. The method of claim 19, wherein the aqueous solution has a pH in a range of about 2.5 to about 8.

22. The method of claim 19, wherein the transition metal ions comprise at least one of Ni, Cu, Mn, and Co ions.

23. The method of claim 22, wherein in-situ Raman analysis is used to differentiate Cu²⁺ and Ni²⁺ adsorption mechanisms onto the metal cation-capturing membrane.
